(19) United States
(12) Patent Application Publication
(10) Pub. No.: US 2026/0245368 A1
(43) Pub. Date: Aug. 20, 2026

(54) ADAPTIVE PERSON RE-IDENTIFICATION

(71) Applicant: Infosys Limited, Bangalore (IN)

(72) Inventors: Ramjee Rajasekaran, Bengaluru (IN); Sidharth Subhash Ghag, Pune (IN)

(73) Assignee: Infosys Limited, Bangalore (IN)

(21) Appl. No.: 19/091,465

(22) Filed: Mar. 26, 2025

(30) Foreign Application Priority Data
Feb. 17, 2025 (IN) 202541013528

(51) Int. Cl. G06V 20/52; G06V 10/62; G06V 10/77; G06V 10/776; G06V 10/82; G06V 20/40; G06V 40/10; G06V 40/50

(52) U.S. Cl. CPC G06V 20/52; G06V 10/62; G06V 10/7715; G06V 10/776; G06V 10/82; G06V 20/46; G06V 40/10; G06V 40/50

(57) ABSTRACT

Adaptive person re-identification technique is provided in the present disclosure. A reference feature profile is created for each individual present in a multi-camera facility. The reference feature profile is indicative of a reference appearance (e.g., apparel and/or accessories) of the individual. In a real-time video frame, a user and a user appearance are detected. Further, a current feature profile is generated for the user based on the detected appearance. The reference feature profile of the detected user is then compared with the current feature profile to detect an appearance-change event. The appearance-change event may be addition/removal of an apparel, addition/removal of an accessory, or a combination thereof. If the appearance-change event is validated, the reference feature profile of the user is updated with the current feature profile. The updated reference feature profile is then utilized for re-identification.

### CROSS-REFERENCE TO RELATED APPLICATIONS

This application claims priority to Indian Application No. 202541013528, filed on Feb. 17, 2025, the entire contents of which are incorporated herein by reference.

### FIELD OF THE DISCLOSURE

Various embodiments of the present disclosure relate generally to image processing. More specifically, various embodiments of the present disclosure relate to adaptive person re-identification.

### BACKGROUND

Cameras have become ubiquitous in public and private spaces, serving diverse applications such as surveillance, security, retail, or the like. In many of these applications, there is an increasing need to accurately identify and track individuals across multiple camera views to enhance monitoring, security, and operational efficiency. Traditionally, this task has relied heavily on human operators, such as security personnel, who manually observe and analyze feeds from multiple cameras to identify and follow the individuals. However, this manual approach is not only labor-intensive and prone to fatigue but also susceptible to errors and inconsistencies, which may compromise the effectiveness of monitoring systems.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for adaptive person re-identification are provided substantially as shown in, and described in connection with, at least one of the figures.

The systems disclosed herein include processing circuitry. The processing circuitry is configured to detect, in a first video frame, a user and an appearance of the user. The appearance of the user is indicative of at least one of a set of apparel or a set of accessories associated with the user. The processing circuitry is further configured to generate a current feature profile for the user based on the detected appearance. Further, the processing circuitry is configured to obtain a reference feature profile of the user. The reference feature profile is indicative of a historical appearance of the user. The processing circuitry is further configured to compare the current feature profile and the reference feature profile, and detect an appearance-change event associated with the user based on a mismatch between the current feature profile and the reference feature profile. Further, the processing circuitry is configured to update the reference feature profile with the current feature profile based on the detection of the appearance-change event. Re-identification associated with the user is executed based on the updated reference feature profile.

In some embodiments, the historical appearance of the user corresponds to the appearance of the user detected in a second video frame that is previous to the first video frame.

In some embodiments, the systems disclosed herein further include a storage element configured to store a profile database. The profile database includes a mapping between a plurality of users and a plurality of reference feature profiles associated therewith. The processing circuitry is coupled to the storage element, and configured to identify, from the plurality of reference feature profiles, the reference feature profile associated with the user.

In some embodiments, the processing circuitry is configured to identify the reference feature profile associated with the user based on trajectory data associated with the user and a location associated with the first video frame.

In some embodiments, the processing circuitry is further configured to detect, in a second video frame that is previous to the first video frame, the user and the historical appearance of the user, determine whether the detection of the user corresponds to a first-time detection, and generate the reference feature profile of the user based on the detection of the user corresponding to the first-time detection.

In some embodiments, the processing circuitry detects the user and the appearance of the user using at least one of a group consisting of an object detection model, a vision language model (VLM), or an instance segmentation model.

In some embodiments, the appearance-change event corresponds to an addition or a removal of at least one apparel of the set of apparel or at least one accessory of the set of accessories.

In some embodiments, the processing circuitry is further configured to validate the appearance-change event. The reference feature profile is updated based on the validation of the appearance-change event.

In some embodiments, the appearance-change event indicates one or more changes in the appearance of the user. The processing circuitry is further configured to determine a user action performed by the user. The processing circuitry validates the appearance-change event based on the user action matching the one or more changes.

In some embodiments, to determine the user action, the processing circuitry is further configured to obtain a set of video frames and process, using an action recognition model, the obtained set of video frames. The set of video frames comprises at least one of a group consisting of a first subset of video frames preceding the first video frame or a second subset of video frames succeeding the first video frame.

In some embodiments, the first video frame is associated with a first image-capturing unit. At least one of the first subset of video frames is associated with a second image-capturing unit, and at least one of the second subset of video frames is associated with a third image-capturing unit. Placement of the second image-capturing unit and the third image-capturing unit is within a predefined distance of placement of the first image-capturing unit.

In some embodiments, the determination of the user action is triggered based on the detection of the appearance-change event.

In some embodiments, the processing circuitry is further configured to process, using a feature extractor model trained with cosine metric learning and contrastive loss, the detected appearance of the user to generate the current feature profile of the user.

In some embodiments, the processing circuitry is further configured to detect one or more additional attributes of the user. The one or more additional attributes correspond to at least one of a group consisting of one or more facial features, a gait pattern, height, or a body shape of the user. The processing circuitry generates the current feature profile of the user further based on the one or more additional attributes.

In some embodiments, each of the current feature profile and the reference feature profile corresponds to at least one of a group consisting of a set of state vectors or an embedding vector. The set of state vectors indicates presence or absence of each of the set of apparel and the set of accessories. The embedding vector is generated for the user based on processing of the detected appearance of the user using a feature extractor model trained with cosine metric learning and contrastive loss.

In some embodiments, when the appearance-change event is detected, a difference between the embedding vector of the current feature profile and the embedding vector of the reference feature profile is within a tolerance range based on the cosine metric learning and contrastive loss.

In some embodiments, the processing circuitry is further configured to simulate, based on the updated reference feature profile, one or more appearance variations for the user. The re-identification associated with the user is executed further based on the one or more appearance variations.

In some embodiments, the processing circuitry simulates the one or more appearance variations using at least one of a group consisting of a generative adversarial network or a stable diffusion model.

In some embodiments, the processing circuitry is further configured to receive a third video frame that is after the first video frame and detect, in the third video frame, the user and another appearance of the user. The processing circuitry is further configured to generate another feature profile for the user based on the appearance detected in the third video frame. Further, the processing circuitry is configured to obtain the updated reference feature profile of the user, compare the updated reference feature profile and the other feature profile generated using the third video frame, and re-identify the user based on a match between the updated reference feature profile and the other feature profile generated using the third video frame.

In another embodiment of the present disclosure, a method is disclosed. The method comprises detecting, by processing circuitry, in a first video frame, a user and an appearance of the user. The appearance of the user is indicative of at least one of a set of apparel or a set of accessories associated with the user. The method further comprises generating, by the processing circuitry, a current feature profile for the user based on the detected appearance. Further, the method comprises obtaining, by the processing circuitry, a reference feature profile of the user. The reference feature profile is indicative of a historical appearance of the user. The method further comprises comparing, by the processing circuitry, the current feature profile and the reference feature profile, and detecting, by the processing circuitry, an appearance-change event associated with the user based on a mismatch between the current feature profile and the reference feature profile. Further, the method comprises updating, by the processing circuitry, the reference feature profile with the current feature profile based on the detection of the appearance-change event. Re-identification associated with the user is executed based on the updated reference feature profile.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates an adaptive person re-identification (ReID) environment, consistent with disclosed embodiments of the present disclosure;

FIG. 2 is a block diagram of processing circuitry of the adaptive person ReID environment of FIG. 1, consistent with disclosed embodiments of the present disclosure;

FIG. 3 is a schematic diagram that illustrates an example scenario of an adaptive person ReID technique, consistent with disclosed embodiments of the present disclosure;

FIGS. 4A and 4B, collectively, represents a flowchart that illustrates a method for adaptive person ReID, consistent with disclosed embodiments of the present disclosure; and

FIG. 5 shows an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Conventionally, to accurately identify and track individuals in multi-camera facilities, person re-identification (ReID) systems may be employed. These systems leverage advanced machine learning and image processing techniques to process images or video frames, extract distinct features, and use these features for person identification. For instance, ReID systems often utilize convolutional neural networks to extract static visual features such as body shape, clothing color, textures, or similar attributes. These recorded features are then compared with real-time data to detect and track individuals. Additional methods, such as face recognition and gait analysis, are also employed to identify individuals based on facial features or walking patterns, respectively.

While these techniques are effective in controlled or static environments, they encounter significant challenges in dynamic and crowded settings. Static visual features may fail when an individual's appearance changes, such as a change in clothing or accessories. Similarly, face recognition models struggle with reduced accuracy when faces are obscured or not visible, such as in wide-angle views or crowded scenes where cameras capture full-body images rather than close-ups. Gait analysis models may also be insufficient in crowded environments where an individual's movement is partially or completely obscured. These limitations make conventional approaches vulnerable to false positives, especially for individuals with similar appearances or those who frequently change their visual traits.

The present disclosure addresses the above limitations by providing a system and a method that uses adaptive person ReID techniques. In the present disclosure, a reference feature profile is created for each individual. The reference feature profile may be indicative of a reference appearance of the individual. An appearance may indicate various apparel and/or accessories worn by the individual. A feature profile may include a set of state vectors that indicates presence or absence of each apparel or accessories, and an embedding vector generated by processing the appearance using a feature extractor model trained with cosine metric learning and contrastive loss. These reference feature profiles are utilized for ReID.

For example, in a real-time video frame, a user and an appearance of the user may be detected. Various object detection models, vision language models, and instance segmentation models may be utilized for the detection. Further, a current feature profile may be generated for the user based on the detected appearance. The appearance may be processed using the feature extractor model trained with cosine metric learning and contrastive loss to generate the current feature profile. Additional attributes such as facial features, a gait pattern, height, or a body shape of the user may also be utilized to generate the current feature profile. The reference feature profile of the detected user is then compared with the current feature profile to detect an appearance-change event. The appearance-change event may be an addition of an apparel, an addition of an accessory, a removal of an apparel, a removal of an accessory, or the like. If the appearance-change event is validated, the reference feature profile of the user is updated with the current feature profile. In some scenarios, the update may correspond to only portions of the feature profile (e.g., parts which have changed) while retaining unchanged regions. The updated feature profile may then be utilized for ReID.

The present disclosure thus allows for effective person ReID in dynamic and crowded settings. As the feature profile is dynamically updated for every appearance-change event, a change in clothing or accessories may not affect ReID. Further, embedding vectors (e.g., a semantic context associated with an individual) do not vary drastically with changes in appearance or obscured facial features and gait. Thus, the utilization of embedding vectors may ensure ReID accuracy in areas with face recognition models and gait analysis models may also be insufficient. The ReID technique of the present disclosure thus significantly reduces the false positive detections as compared to conventional approaches. Further, the ReID technique of the present disclosure is devoid of any human intervention. Therefore, human errors may also be avoided. The application area of the present disclosure may include any domain that utilizes person ReID systems. It is appreciated that the human mind is not equipped to conceptualize and engineer accurate, effective, and dynamic person ReID in multi-camera facilities such as retail stores, airports, or the like, given the digital interconnectedness of person ReID systems.

### Figure Description

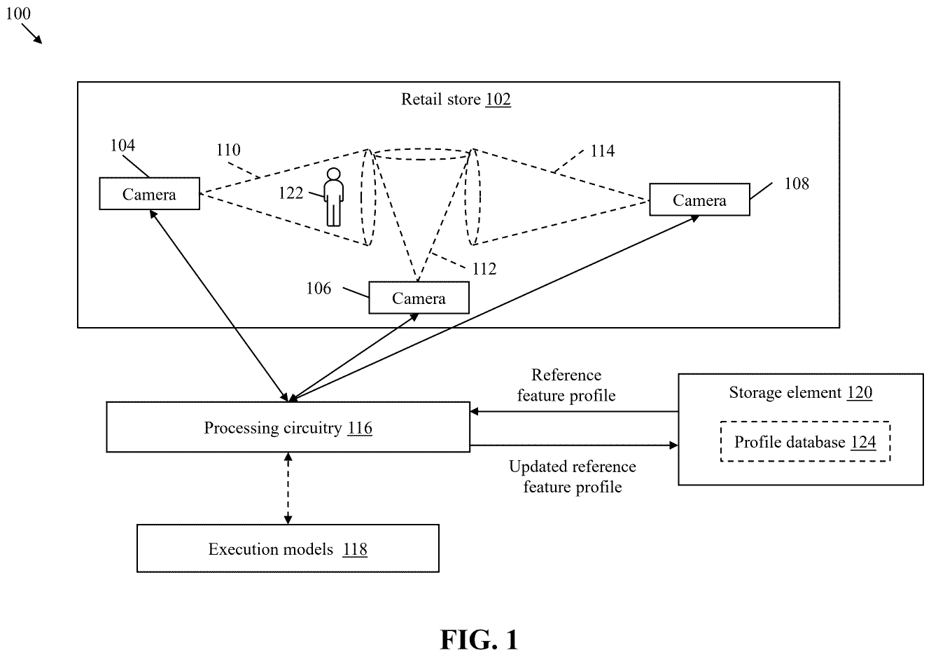

FIG. 1 is a schematic diagram that illustrates an adaptive person re-identification (ReID) environment 100, consistent with disclosed embodiments of the present disclosure. The adaptive person ReID environment 100 includes a retail store 102. The retail store 102 may include various image-capturing units to monitor various sections thereof. The placement of the image-capturing units in the retail store 102 may be such that key areas such as entrances, aisles, checkouts, and other high-traffic zones, are covered. The image-capturing units may also be positioned to capture different angles of an individual's body, face, and accessories. In an embodiment, the image-capturing units may be fixed. In another embodiment, the position of the image-capturing units may be dynamically adjusted based on user activity in the retail store 102. For the sake of brevity, the retail store 102 is shown to include three image-capturing units (e.g., image-capturing units 104-108). However, the scope of the present disclosure is not limited to it. In numerous embodiments, the retail store 102 may include more than three image-capturing units covering the majority of the retail store 102.

In an embodiment, an image-capturing unit may correspond to a camera. Thus, the image-capturing units 104-108 are hereinafter referred to as “cameras 104-108”. The placement of the cameras 104-108 may be within a predefined distance of each other. In an example, the predefined distance corresponds to 4 meters. However, in other embodiments, the predefined distance may have different values. Each camera has a field-of-view (FOV) that defines the extent of the observable scene captured by the camera lens. In other words, each camera may be configured to continuously capture a video of the associated FOV. The cameras 104-108 have FOVs 110-114, respectively. As illustrated in FIG. 1, the FOVs 110-114 may collectively cover a section of the retail store 102.

Conventionally, in multi-camera facilities (such as the retail store 102), person ReID systems are commonly used to identify and track individuals for enhancing monitoring, security, and operational efficiency. These systems employ advanced machine learning (ML) and image processing techniques to analyze images or video frames captured by the cameras (e.g., the cameras 104-108), extract distinctive features (e.g., body shape, clothing colors, textures, or the like) and identify individuals using convolutional neural networks (CNNs). These extracted features are then compared with real-time data to detect and track individuals effectively. Additionally, complementary methods such as face recognition and gait analysis enhance identification by leveraging facial features and walking patterns, respectively, offering a multi-faceted approach to accurate person identification.

These techniques, while effective in controlled or static environments, encounter significant challenges in dynamic and crowded settings. For example, in the retail store 102, people often spend considerable time browsing or purchasing multiple items, during which they may change their appearance by adding or removing their apparel or accessories. Utilization of static visual features may fail in such appearance-change events. Additionally, while moving through the retail store 102, a person's facial visibility and/or gait may be obstructed, obscured, or not visible. In such scenarios, face recognition models and gait analysis models may struggle with reduced accuracy. These limitations make conventional approaches vulnerable to false positives, especially for individuals with similar appearances or those who frequently change their visual traits.

To overcome these challenges, an adaptive person ReID technique is disclosed in the present disclosure. To facilitate such an adaptive person ReID technique, the adaptive person ReID environment 100 may further include processing circuitry 116, execution models 118, and a storage element 120. The processing circuitry 116, the execution models 118, and the storage element 120 collectively form a ReID system of the present disclosure that executes the adaptive person ReID technique. The adaptive person ReID technique of the present disclosure is utilized to effectively identify and track individuals in the retail store 102 even during events of appearance changes, obscuring of visual features or walking patterns, or the like. The adaptive person ReID technique of the present disclosure is explained in detail below.

### Adaptive Person Reid

The processing circuitry 116 may include suitable logic, circuitry, interfaces, and/or code, executable by the circuitry, that may be configured to execute the adaptive person ReID in the retail store 102. The processing circuitry 116 may be coupled to the cameras 104-108, and may be configured to receive the video captured by each of the cameras 104-108.

### Reference Feature Profile Creation

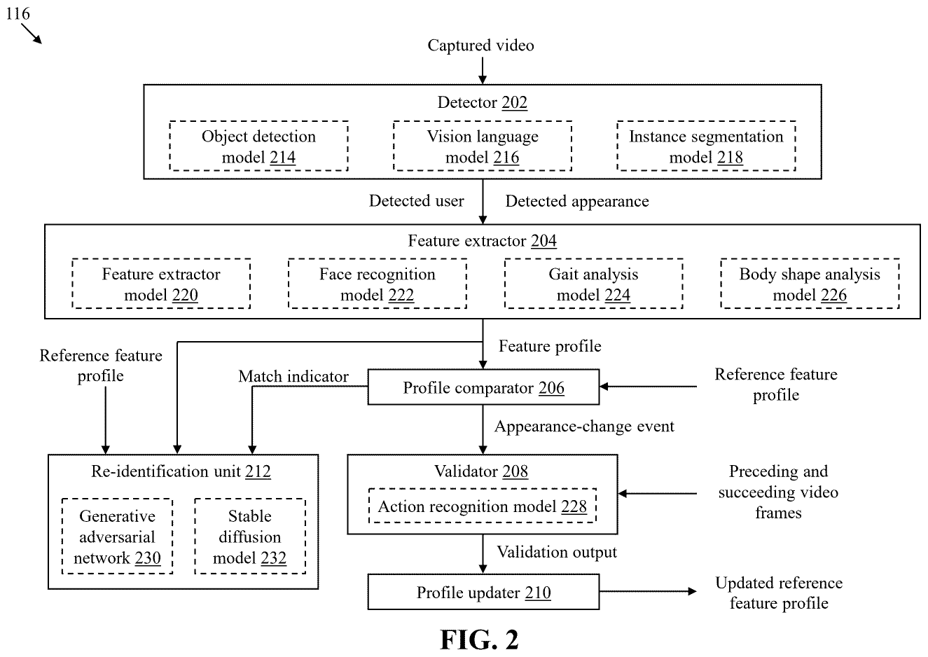

In an embodiment, it is assumed that the camera 104 covers the entrance of the retail store 102. Thus, the processing circuitry 116 may be configured to detect, in a video frame captured by the camera 104, a user 122 and an appearance of the user 122. The appearance may be indicative of at least one of a set of apparel or a set of accessories associated with the user 122. Examples of an apparel may include a t-shirt, a shirt, jeans, a jacket, footwear, a hat, a cap, or the like. Further, examples of an accessory may include glasses, jewelry, a watch, or the like. In an embodiment, the processing circuitry 116 detects the user 122 and the appearance of the user 122 using at least one of the execution models 118. The execution models 118 may include various artificial intelligence (AI) models that are utilized by the processing circuitry 116 for the execution of the adaptive person ReID technique of the present disclosure. For the detection operation, the execution models 118 may include at least one of a group consisting of an object detection model, a vision language model (VLM), or an instance segmentation model. In an embodiment, all the object detection model, the VLM, and the instance segmentation model may be utilized for detecting the user 122 and the appearance of the user 122. The object detection model, the VLM, and the instance segmentation model are explained in detail in FIG. 2.

The processing circuitry 116 may be further configured to determine whether the detection of the user 122 corresponds to a first-time detection. As the camera 104 is placed at the entrance, the detection using the video frame of the camera 104 corresponds to the first-time detection. Based on the detection of the user 122 corresponding to the first-time detection, the processing circuitry 116 may be further configured to generate a reference feature profile for the user 122. In an embodiment, the processing circuitry 116 may be configured to process, using at least one of the execution models 118, the detected appearance of the user 122 to generate the reference feature profile of the user 122. In such a scenario, the execution models 118 may include a feature extractor model trained with cosine metric learning and contrastive loss. The feature extractor model is explained in detail in FIG. 2.

The reference feature profile may include at least one of a set of state vectors and an embedding vector. The set of state vectors may indicate presence or absence of each of the set of apparel and the set of accessories. In other words, the set of state vectors may include a state vector for each apparel or accessory and an indication of whether the corresponding apparel or accessory is present or absent (e.g., worn or not worn by the user 122). The embedding vector may be generated for the user 122 based on processing of the detected appearance of the user 122 using the feature extractor model trained with cosine metric learning and contrastive loss.

The processing circuitry 116 may be further coupled to the storage element 120. The storage element 120 may correspond to a hardware storage (for example, hard drive, solid-state drive, or the like) or a cloud storage (for example, cloud services). The storage element 120 may be configured to store a profile database 124. The profile database 124 may include a mapping between a plurality of users present in the retail store 102 and a plurality of reference feature profiles associated therewith. In other words, for each user, one reference feature profile is mapped (i.e., generated and mapped). The processing circuitry 116 may be configured to store a mapping between the user 122 and the reference feature profile in the profile database 124. This reference feature profile of the user 122 may be utilized for the ReID.

### Appearance-Change Event

As the user 122 moves through the retail store 102, the user 122 may enter the FOVs of different cameras. For example, the user 122 may enter the FOV 112 of the camera 106. It is also assumed that the user 122 may remove one piece of apparel (e.g., a jacket) while entering the FOV 112. Thus, the processing circuitry 116 may be configured to detect, in a video frame captured by the camera 106, the user 122 and the appearance of the user 122. The appearance detected in the video frame is the current appearance of the user 122. In an embodiment, the processing circuitry 116 detects the user 122 and the appearance of the user 122 using the object detection model, the VLM, the instance segmentation model, or a combination thereof. The utilization of the VLM ensures that the current feature profile includes the semantic context of the appearance and the user 122 which helps ReID even when the appearance of the user 122 changes.

The processing circuitry 116 may be further configured to generate a current feature profile for the user 122 based on the detected appearance. In an embodiment, the processing circuitry 116 may be configured to process, using the feature extractor model trained using cosine metric learning and contrastive loss, the detected appearance of the user 122 to generate the current feature profile of the user 122.

The current feature profile, like the reference feature profile, may include at least one of the set of state vectors and the embedding vector. The set of state vectors may indicate presence or absence of each of the set of apparel and the set of accessories. The embedding vector may be generated for the user 122 based on the processing of the detected appearance of the user 122 using the feature extractor model trained with cosine metric learning and contrastive loss.

The processing circuitry 116 may be further configured to obtain the reference feature profile of the user 122. The reference feature profile may be indicative of a historical appearance of the user 122. The historical appearance of the user 122 corresponds to the appearance of the user 122 detected in the video frame captured by the camera 104 that is previous (e.g., captured prior) to the video frame captured by the camera 106. In an embodiment, the processing circuitry 116 may be configured to identify, from the plurality of reference feature profiles stored in the profile database 124, the reference feature profile associated with the user 122.

The scope of the present disclosure is not limited to the user-profile mapping being used for the reference feature profile identification. In several embodiments, the profile database 124 may further include trajectory data tracked for each user mapped thereto. The trajectory data may include the path traveled by the user 122 in the retail store 102. The use of trajectory data ensures that the entire profile database 124 is not required to be searched to identify the reference feature profile of the user 122. In an embodiment, the trajectory data stored for each user may be utilized to predict the next location of the corresponding user. Exclusively the users whose predicted location matches the location of the camera 106 may be searched for the reference feature profile identification. For example, after the first-time detection of the user 122, the user 122 is tracked in the retail store 102 using various trajectory tracking techniques. After each accurate detection, the next predicted location for the user 122 is determined. Further, during a user detection event in the FOV of the camera 106, the profile database 124 is accessed to determine which users are predicted to be present in the FOV of the camera 106 and exclusively the users (e.g., the user 122) whose predicted location matches the location of the camera 106 may be searched for the reference feature profile identification. This significantly reduces the computational load on the processing circuitry 116 and increases the accuracy of identification. Thus, to summarize, the processing circuitry 116 may be further configured to identify, from the plurality of reference feature profiles, the reference feature profile associated with the user 122 based on the trajectory data associated with the user 122 and the location associated with the video frame captured by the camera 106 (e.g., the location

### Of the Camera 106).

The processing circuitry 116 may be further configured to compare the current feature profile and the reference feature profile. As the user 122 has changed an apparel, the current feature profile does not match the reference feature profile. Based on the mismatch between the current feature profile and the reference feature profile, the processing circuitry 116 may be further configured to detect (i.e., trigger) an appearance-change event associated with the user 122. In the current example, the appearance-change event corresponds to a removal of an apparel (e.g., a jacket) of the set of apparel. However, the scope of the present disclosure is not limited to it. In several embodiments, the appearance-change event may also correspond to an addition of at least one apparel of the set of apparel, a removal of more than one apparel of the set of apparel, an addition of at least one accessory of the set of accessories, a removal of at least one accessory of the set of accessories, or a combination thereof.

The processing circuitry 116 may be further configured to validate the appearance-change event. As described above, the appearance-change event indicates one or more changes in the appearance of the user 122. Further, the processing circuitry 116 may be configured to determine a user action performed by the user 122. The processing circuitry 116 validates the appearance-change event based on the user action matching the one or more changes. In other words, the appearance-change event may indicate that the jacket was part of the historical appearance but not part of the current appearance. In such a scenario, the processing circuitry 116 may determine whether the user 122 has performed the action of removing the jacket to validate the appearance-change event. The determination of the user action is triggered based on the detection of the appearance-change event.

To determine the user action, the processing circuitry 116 may be configured to obtain a set of video frames. The set of video frames may include a first subset of video frames preceding the video frame captured by the camera 106, a second subset of video frames succeeding the video frame captured by the camera 106, or a combination thereof. In an embodiment, the first subset of video frames includes 20 frames preceding the video frame captured by the camera 106 and the second subset of video frames includes 20 frames succeeding the video frame captured by the camera 106. Some of these video frames may be captured by cameras which are placed within the predefined distance of placement of the camera 106. For example, at least one of the first subset of video frames is associated with the camera 104 and at least one of the second subset of video frames is associated with the camera 108. Thus, video frames from the cameras 104 and 108 which are in the vicinity of the camera 106 may be utilized. In an embodiment, the cameras 104-108 may be configured to store the captured video (e.g., the video frames) in the storage element 120, and the processing circuitry 116 may obtain the set of video frames from the storage element 120.

The processing circuitry 116 may be further configured to process, using at least one of the execution models 118, the obtained video frames to determine the user action. In an embodiment, the execution models 118 may include an action recognition model for processing the obtained video frames. The action recognition model is explained in detail in FIG. 2. A successful validation of the appearance-change event ensures that the detected change corresponds to an intentional user action. An unsuccessful validation may result in no further action.

Based on the successful validation of the appearance-change event, the processing circuitry 116 may be further configured to update the reference feature profile of the user 122 in the profile database 124 with the current feature profile of the user 122. The ReID associated with the user 122 is executed based on the updated reference feature profile. In other words, the future ReID associated with the user 122 is executed based on the updated appearance of the user 122.

### ReID

The processing circuitry 116 may be configured to detect, in a video frame captured by the camera 108, the user 122 and the appearance of the user 122. In other words, the user 122 is detected in the FOV 114 of the camera 108. The detected appearance is the current appearance of the user 122. The processing circuitry 116 may be further configured to generate a current feature profile for the user 122 based on the appearance detected in the video frame captured by the camera 108. The processing circuitry 116 may be further configured to obtain the reference feature profile of the user 122 stored in the profile database 124. In other words, the processing circuitry 116 may obtain the updated reference feature profile of the user 122. The processing circuitry 116 may be further configured to compare the current feature profile and the obtained reference feature profile. In this scenario, if the appearance of the user 122 has not changed, the current feature profile may match the obtained reference feature profile. Based on the match between the current feature profile and the obtained reference feature profile, the processing circuitry 116 may be further configured to re-identify the user 122.

The scope of the present disclosure is not limited to the above-mentioned ReID. In some cases, the user 122 may move into areas which are outside the coverage of any camera. For example, the user 122 may enter a changing room. In such cases, the processing circuitry 116 may be further configured to simulate, based on the updated reference feature profile, one or more appearance variations for the user 122. The processing circuitry 116 simulates the one or more appearance variations using at least one of the execution models 118. In an embodiment, the execution models 118 may include a generative adversarial network (GAN) or a stable diffusion model to simulate the one or more appearance changes. The GAN and the stable diffusion model are explained in detail in FIG. 2. Further, if prior to entering the changing room, the apparel and/or accessories carried by the user 122 are detected, the one or more appearance variations may be simulated in the context of these apparel and/or accessories. Thus, when the user 122 re-enters any camera FOV in the changed attire, the ReID associated with the user 122 may be executed based on the one or more appearance variations. In other words, the updated reference feature profile with the one or more appearance variations are compared with the current feature profile generated for the user 122.

The present disclosure thus allows for effective person ReID in dynamic and crowded settings. As the feature profile is dynamically updated for every appearance-change event, a change in clothing or accessories may not affect ReID. Further, when the appearance-change event is detected, a difference between the embedding vector of the current feature profile and the embedding vector of the reference feature profile is within a tolerance range based on the cosine metric learning and contrastive loss. In other words, embedding vectors (e.g., a semantic context associated with an individual) do not vary drastically with changes in appearance or obscured facial features and gait. Thus, the utilization of embedding vectors may ensure ReID accuracy in areas where face recognition models and gait analysis models may also be insufficient. The ReID technique of the present disclosure thus significantly reduces the false positive detections as compared to conventional approaches. Thus, the fusion of visual features (e.g., that are extracted through object detection for accessories and changes in appearance), temporal patterns (e.g., that are derived from sequences of frames to analyze motion and actions), and semantic context (e.g., that is provided by VLMs which describe changes in natural language) render the ReID technique of the present disclosure more effective and accurate than conventional approaches.

The ReID technique of the present disclosure is devoid of any human intervention. Therefore, human errors may also be avoided. Additionally, a crowded setting, such as the retail store 102, includes a large number of people. In the present disclosure, the trajectory data of each user is utilized to limit the search space that is used for identifying the reference feature profile. This significantly reduces the computational load on the processing circuitry 116 and the advantage is exponential when measured in the context of the large number of people present in the retail store 102. As a result, the ReID technique of the present disclosure is more efficient and effective as compared to conventional ReID techniques where the features are compared with the entire master database of static user features.

The scope of the present disclosure is not limited to the use of state vectors and embedding vectors for the feature profile creation. In several embodiments, the processing circuitry 116 may be further configured to detect one or more additional attributes of the user 122. The one or more additional attributes may correspond to at least one of a group consisting of one or more facial features, a gait pattern, height, or a body shape of the user 122. The one or more facial features may correspond to facial landmarks, facial geometry, skin texture, proportions and distances between features such as inter-ocular distance, nose-to-mouth distance, ear position, facial expressions, or any other unique identification characteristics. Further, the gait pattern may correspond to stride length, step length, step frequency, walking speed, swing and stance phases, knee and leg motion, upper body movement, posture and alignment, foot placement and angles, or the like. The processing circuitry 116 may use at least one of the execution models 118 to detect the one or more additional attributes. In an embodiment, the execution models 118 may include a face recognition model, a gait analysis model, a body shape analysis model, or a combination thereof to detect the one or more additional attributes. The face recognition model, the gait analysis model, and the body shape analysis model are explained in detail in FIG. 2. Further, the processing circuitry 116 may generate a feature profile (e.g., the reference feature profile and/or the current feature profile) of the user 122 based on the one or more additional attributes detected in the corresponding video frame.

Thus, in the retail store 102, the movement of a person (e.g., the user 122) is tracked via the cameras (e.g., the cameras 104-108), maintaining continuity of identity across the entire store. The adaptive person ReID implemented in the retail store 102 may be utilized for consistent customer identification even when customers change apparel or accessories, enabling personalized promotions and preventing theft or fraud. The profile database 124 maintains a record of each individual entering the retail store 102. In some embodiments, a record for the user 122 may include an identifier (ID) of the user 122, the video frames and camera location information, and timestamps. In such a scenario, the processing circuitry 116 may be configured to reconstruct a video of the movement of the user 122 through the retail store 102 using the stored record. This video may be utilized for the detection of user actions. Thus, the accuracy of person ReID is further improved by spatiotemporal matching, which combines spatial information (the location of each camera) with temporal data. The scope of the present disclosure is not limited to the person ReID in the retail store 102. In numerous embodiments, the adaptive person ReID technique of the present disclosure may be implemented in any scenario where individuals are tracked over time, even when they change their appearance by adding/removing apparel or accessories.

In one example, the adaptive person ReID technique of the present disclosure may be implemented in surveillance systems used in public spaces like airports, train stations, shopping malls, and city streets. In another example, the adaptive person ReID technique of the present disclosure may be implemented in smart city infrastructure to facilitate long-term monitoring and identification of individuals in urban environments, supporting traffic management, public safety, and crime prevention efforts. In yet another example, the adaptive person ReID technique of the present disclosure may be implemented in access control and security applications to improve security in restricted areas like corporate campuses or event venues, where authorized personnel need to be identified regardless of the appearance changes. In yet another example, the adaptive person ReID technique of the present disclosure may be implemented in healthcare facilities to ensure accurate patient or personnel tracking, where individuals may frequently change their clothing (e.g., gowns or uniforms).

Although it is described that the entire reference feature profile (e.g., the set of state vectors and the embedding vector) is updated in the event of appearance change, the scope of the present disclosure is not limited to it. In some scenarios, the update may correspond to only portions of the feature profile (e.g., the state vectors that have changed) while retaining unchanged regions.

FIG. 2 is a block diagram of the processing circuitry 116, consistent with disclosed embodiments of the present disclosure. As illustrated in FIG. 2, the processing circuitry 116 may include a detector 202, a feature extractor 204, a profile comparator 206, a validator 208, a profile updater 210, and a re-identification unit 212.

The operations performed by the processing circuitry 116 may be largely classified into three parts: generation of the initial feature profiles (e.g., the reference feature profiles) for various users, detection of the appearance-change events and the reference feature profile update, and utilization of the updated reference feature profiles for ReID. The operations involved in the generation of the reference feature profile based on the user features captured at the entrance of the retail store 102 and the operations involved in the generation of the current feature profiles based on the user features captured in each subsequent video frame remain the same. Thus, in FIG. 2, the operations of the detector 202 and the feature extractor 204 are explained for the generation of one feature profile (e.g., the current feature profile). The same operations may be executed for the generation of the reference feature profile. Although not shown, the processing circuitry 116 may include a user management unit that may be configured to determine whether a user is detected for the first time and initiate the reference feature profile generation for the same. Further, for the sake of simplicity, the adaptive person ReID technique of the present disclosure is explained for one user (e.g., the user 122). Similar operations may be executed for all other users present in the retail store 102.

The detector 202 may be coupled to the cameras 104-108. The detector 202 may include suitable logic, circuitry, interfaces, and/or code, executable by the circuitry, that may be configured to perform one or more operations. For example, the detector 202 may be configured to receive the video captured by each of the cameras 104-108. The detector 202 may be further configured to detect, in a video frame, the user 122 and the appearance of the user 122. The detector 202 may utilize an object detection model 214, a VLM 216, an instance segmentation model 218, or a combination thereof, to detect the user 122 and the appearance of the user 122. The execution models 118 may include the object detection model 214, the VLM 216, and the instance segmentation model 218.

The object detection model 214 is a type of ML model designed to identify and locate objects within an image or video. The object detection model 214 not only classifies objects into predefined categories but also outputs bounding boxes indicating their positions. For example, the object detection model 214 may localize the face of the user 122 within the video frame by outputting a bounding box. Examples of the object detection model 214 may include You Only Look Once (YOLO) model, Faster Region-Based CNN (R-CNN), Mask R-CNN, or the like.

The VLM 216 is a type of AI model designed to process and understand information across both visual and textual modalities. Examples of the VLM 216 may include Contrastive Language-Image Pretraining (CLIP), Bootstrapped Language-Image Pretraining (BLIP), or the like. The VLM 216 may integrate computer vision and natural language processing to generate semantic feature information. In simple terms, the VLM 216 processes both the image and text present in the input and generates a text-based output upon extracting sparse features by interpreting contextual relationships between vision and language. For example, the VLM 216 may process the video frame of the user 122 and interpret semantic descriptors useful for identifying the user 122 based on their appearance. The semantic description of the person may include an appearance description (e.g., a person wearing a blue bottom wear, a brown jacket, a cap, and glasses). The VLM 216 may build semantic connections between the received video frames, even when visual features vary significantly. For example, if a person changes apparel, traditional visual matching might fail due to feature vector differences. However, the semantic descriptions detected by the VLM 216 bridge this gap, ensuring robust matching across changes in appearance. For instance, the VLM 216 detects appearance based on the visual features, and detects if the person is wearing a cap, glasses, a watch, or a jacket. Based on the detection, the VLM 216 generates either a ‘yes’ or a ‘no’ as a response for each query, providing a context-aware information.

The instance segmentation model 218 is a specialized computer vision model that identifies and delineates each individual object in an image, assigning a distinct segmentation mask to every instance of a detected object. This task is more granular than object detection (which only identifies the bounding boxes) and semantic segmentation (which labels pixels but does not distinguish between instances). Examples of the instance segmentation model 218 may include Mask R-CNN, Detectron2, You Only Look At Coefficients (YOLACT), or the like. The instance segmentation model 218 may be configured to distinguish between different objects of the same class (e.g., two or more users) and assign a unique label to each instance. Once individual persons are segmented, the instance segmentation model 218 identifies and tracks each person across different frames or scenes, based on unique visual features like apparel, accessories, appearance, and pose.

The detector 202 thus combines the characteristics of the object detection model 214, the VLM 216, and the instance segmentation model 218 for detecting the user 122 and the appearance of the user 122. For example, the received video frame is processed through the object detection model 214, the instance segmentation model 218, and the VLM 216 to identify persons in the received video frame by detecting objects that belong to the “person” class. The detected objects are segmented at the pixel level to identify individuals in complex environments where multiple people may overlap, occlude each other, or be close to one another. The integration of the object detection model 214, the VLM 216, and the instance segmentation model 218 leads to accurate and precise user and appearance detection in complex real-world scenarios.

The feature extractor 204 may be coupled to the detector 202. The feature extractor 204 may include suitable logic, circuitry, interfaces, and/or code, executable by the circuitry, that may be configured to perform one or more operations. For example, the feature extractor 204 may be configured to generate a feature profile for the user 122 based on the detected appearance of the user 122. As illustrated in FIG. 2, the feature extractor 204 may utilize a feature extractor model 220, a face recognition model 222, a gait analysis model 224, and a body shape analysis model 226 to generate the feature profile.

The feature profile may include the set of state vectors and/or the embedding vector. Each state vector may indicate presence or absence of an apparel or an accessory. The embedding vector may be generated based on processing the detected appearance using the feature extractor model 220. In an embodiment, the feature extractor 204 may involve a convolution-based feature extraction function that may generate a compressed version of the appearance of the user 122 in a latent space. This compressed version of the appearance of the user 122 in the latent space may be referred to as the embedding vector.

The feature extractor model 220 is trained with cosine metric learning and contrastive loss. The feature extractor model 220 may include CNNs or transformer-based models. The feature extractor model 220 is trained for detecting appearance changes. Although not shown, the processing circuitry 116 may include a training circuit that is configured to execute the training of the execution models 118. The training may focus on learning robust representations of both visual and temporal patterns. A training dataset, comprising sequences of frames where individuals undergo accessory or clothing changes, may be utilized for training the feature extractor model 220. Each sequence of frames, in the training dataset, is labeled with the type of change (e.g., adding/removing/replacing a jacket, hat, or glasses) or marked as no change. A training pipeline for training the feature extractor model 220 employs a two-part architecture. First, the feature extractor model 220 is pre-trained with cosine metric learning approach to generate embeddings for each frame. An embedding is a high-dimensional vector for each input frame, which is a compact representation of essential features of the frame. These embeddings capture the essence of the appearance or content of the frame.

The embeddings are then fed into a temporal module, such as a transformer, a long short-term memory, a recurrent neural network, or the like, designed to capture sequential patterns across frames. This temporal modeling enables the feature extractor model 220 to identify gradual changes and differentiate them from noise or transient movements. A contrastive loss function is used during training to minimize the distance between embeddings of frames with similar appearances while maximizing the distance for frames with distinct changes. In other words, the difference between embeddings for similar appearances is within a tolerance range, and the difference between embeddings for distinct appearances is outside the tolerance range. This approach ensures that subtle changes in appearance may be distinguished effectively. Augmentations like frame skipping, varied lighting, and occlusions are incorporated during training to enhance robustness. The trained feature extractor model 220 is then validated on sequences with known appearance changes. In an embodiment, a test dataset may be utilized for the validation operation. By combining visual and temporal learning, this training process enables precise detection of accessory or clothing changes, laying a strong foundation for adaptive person ReID systems.

The feature profile generated using the feature extractor model 220 may be enhanced by using the face recognition model 222, the gait analysis model 224, and the body shape analysis model 226.

The face recognition model 222 is a type of ML model designed to identify or verify individuals by analyzing facial features. The face recognition model 222 may extract unique facial embeddings from images or videos and compare them to stored templates for matching. Examples of the face recognition model 222 may include FaceNet, DeepFace, ArcFace, or the like. The face recognition model 222 may be utilized to detect the one or more facial features of the user 122. The feature profile generated for the user 122 may be further indicative of the detected one or more facial features.

The integration of the face recognition model 222 with the object detection model 214 and the instance segmentation model 218 allows for continuous tracking and identification of individuals as they move through different areas, based on both their faces and their visual appearance (e.g., clothing). Further, the integration of the VLM 216 with the above models may enhance identification by using semantic descriptions. The semantic descriptions may involve facial attributes (e.g., age, gender, ethnicity, expression, facial hair, eye wear, or the like), facial features (e.g., eye color, nose shape, mouth shape, identification marks, or the like), apparel and accessories, contextual information (location, timestamp, motion), temporal information, and orientation. For example, the semantic description may indicate that the user 122 is wearing a red jacket. This integration enhances performance in a variety of scenarios, such as video surveillance, customer tracking, and personal identification in crowded environments.

The gait analysis model 224 is designed to analyze the unique walking patterns of individuals. For example, the gait analysis model 224 may capture temporal features (e.g., walking speed, stride length, and steps per minute), spatial features (e.g., measurement of the body movement or joints during walking), kinematic features (e.g., joint angles, body sway, and posture changes), and motion-based features (e.g., motion patterns of the entire body or individual limbs while walking). By analyzing the captured features, the gait analysis model 224 may identify individuals, detect abnormalities, and monitor rehabilitation progress. Examples of the gait analysis model 224 may include GaitSet, OpenPose, or the like. In the present disclosure, the gait analysis model 224 may be utilized to detect the gait pattern of the user 122. The feature profile generated for the user 122 may be further indicative of the detected gait pattern.

The body shape analysis model 226 is designed to extract and analyze the geometric and structural features of a human body, often from images or videos. The body shape analysis model 226 identifies key points, contours, or volumetric measurements to assess body proportions and dimensions. For example, the body shape analysis model 226 identifies aspects such as waist-to-hip ratio, limb proportions, and overall body silhouette. Examples of the body shape analysis model 226 may include Skinned Multi-Person Linear Model (SMPL), BodyPix, or the like. In the present disclosure, the body shape analysis model 226 may be utilized to detect the height and the body shape of the user 122. The feature profile generated for the user 122 may be further indicative of the detected height and body shape.

The profile comparator 206 may be coupled to the feature extractor 204 and the storage element 120. The profile comparator 206 may include suitable logic, circuitry, interfaces, and/or code, executable by the circuitry, that may be configured to perform one or more operations. For example, the profile comparator 206 may be configured to receive the feature profile generated by the feature extractor 204. Further, the profile comparator 206 may be configured to obtain the reference feature profile associated with the user 122 from the profile database 124. The profile comparator 206 may identify the reference feature profile associated with the user 122 based on the user-profile mapping, the trajectory data of the user 122, or a combination thereof. Further, the profile comparator 206 may be configured to compare the feature profile generated by the feature extractor 204 with the obtained reference feature profile. If both the profiles match, the profile comparator 206 may be configured to generate a match indicator. Conversely, if both the profiles do not match, the profile comparator 206 may be configured to generate the appearance-change event.

The validator 208 may be coupled to the profile comparator 206. The validator 208 may include suitable logic, circuitry, interfaces, and/or code, executable by the circuitry, that may be configured to perform one or more operations. For example, the validator 208 may be configured to validate the detected appearance-change event. The validator 208 may utilize an action recognition model 228 to validate the appearance-change event.

The action recognition model 228 is a type of ML model designed to identify and classify human actions or activities in videos or live streams. The action recognition model 228 analyzes temporal and spatial patterns of motion and appearance, based on video frames, skeleton data, or optical flow to recognize actions like walking, running, waving, or jumping. Examples of the action recognition model 228 may include Inflated 3D convolutional network, Temporal Segment Networks, or the like.

The validator 208 may be configured to determine the user action performed by the user 122. The appearance-change event indicates one or more changes in the appearance of the user 122. Thus, the appearance-change event is validated based on the user action matching the one or more changes. In other words, the appearance-change event may indicate that the jacket was part of the appearance earlier but now it is not. In such a scenario, the validator 208 may determine whether the user 122 has performed the action of removing the jacket to validate the appearance-change event. The determination of the user action is triggered based on the detection of the appearance-change event. To determine the user action, the validator 208 may be configured to obtain a predefined number of video frames preceding and succeeding the video frame using which the feature profile is generated. The validator 208 may be further configured to process, using the action recognition model 228, the obtained video frames to determine the user action. The validator 208 may be further configured to generate a validation output. An unsuccessful validation output may result in no further action. In several embodiments, the unsuccessful validation output may be flagged for manual review. For example, the processing circuitry 116 may be configured to render a user interface on a display device (not shown) managed by an executive of the retail store 102. A notification or an alert indicating unsuccessful validation may be displayed on the rendered user interface.

Unlike traditional systems, where object detection and action recognition are integrated into a single pipeline, in the present disclosure both operations correspond to distinct flows. Thus, in the present disclosure, the action recognition operation is triggered only when an appearance change is detected. This avoids redundant computation and focuses computational resources on critical moments, improving efficiency and robustness.

The profile updater 210 may be coupled to the validator 208 and the storage element 120. The profile updater 210 may include suitable logic, circuitry, interfaces, and/or code, executable by the circuitry, that may be configured to perform one or more operations. For example, the profile updater 210 may be configured to update the reference feature profile of the user 122 in the profile database 124 with the feature profile of the user 122 generated by the feature extractor 204, based on the successful validation output. The ReID associated with the user 122 is then executed based on the updated reference feature profile. In other words, the future ReID associated with the user 122 is executed based on the updated appearance of the user 122.

The ReID unit 212 may be coupled to the feature extractor 204, the profile comparator 206, and the storage element 120. The ReID unit 212 may include suitable logic, circuitry, interfaces, and/or code, executable by the circuitry, that may be configured to perform one or more operations. For example, the ReID unit 212 may be configured to re-identify the user 122 based on the match indicator generated by the profile comparator 206. Based on the ReID, various operations associated with the user 122 may be executed. For example, a user account may be maintained for each user present in the retail store 102, and based on the successful ReID, items picked up by the user 122 may be linked to a user account of the user 122. In such a scenario, the purchase of all items picked up by the user 122 may be completed directly using the user account, without the user 122 having to visit a billing counter of the retail store 102.

In certain scenarios, the user 122 may move into areas which are outside the coverage of any camera. For example, the user 122 may enter a changing room. In such cases, the ReID unit 212 may be further configured to simulate, based on the reference feature profile, one or more appearance variations for the user 122. The ReID unit 212 may simulate the one or more appearance variations using a GAN 230 or a stable diffusion model 232. Further, if prior to entering the changing room, the apparel and/or accessories carried by the user 122 are detected, the one or more appearance variations may be simulated in the context of these apparel and/or accessories. Thus, when the user 122 re-enters any camera FOV in the changed attire, the ReID associated with the user 122 may be executed based on the one or more appearance variations. In other words, the updated reference feature profile with the one or more appearance variations are compared with the current feature profile generated for the user 122.

The GAN 230 is a class of ML models that consists of two neural networks, a generator and a discriminator, which are trained simultaneously in a competitive process. The generator creates synthetic data samples (e.g., images, videos, or audio), while the discriminator evaluates their authenticity against real samples. This adversarial training allows the GAN 230 to produce highly realistic outputs. Examples of the GAN 230 may include Deep Convolutional GAN, StyleGAN, or the like.

The stable diffusion model 232 is a generative ML framework that transforms random noise into coherent images by iteratively refining the data using a diffusion process. The stable diffusion model 232 operates by learning the reverse of a noise process, progressively denoising inputs to produce high-quality outputs. The stable diffusion model 232 may assist in cross-domain adaptation by generating images in the style or characteristics of the target domain. For example, if the re-identification unit 212 needs to match the person across different cameras (e.g., one with high quality and the other with low quality), the stable diffusion model 232 may generate synthetic images that bridge the gap between the two domains. Further, the stable diffusion model 232 may generate plausible completions of the missing parts of an image (such as reconstructing a person's face or body from partial observations), helping the ReID unit 212 deal with occlusions.

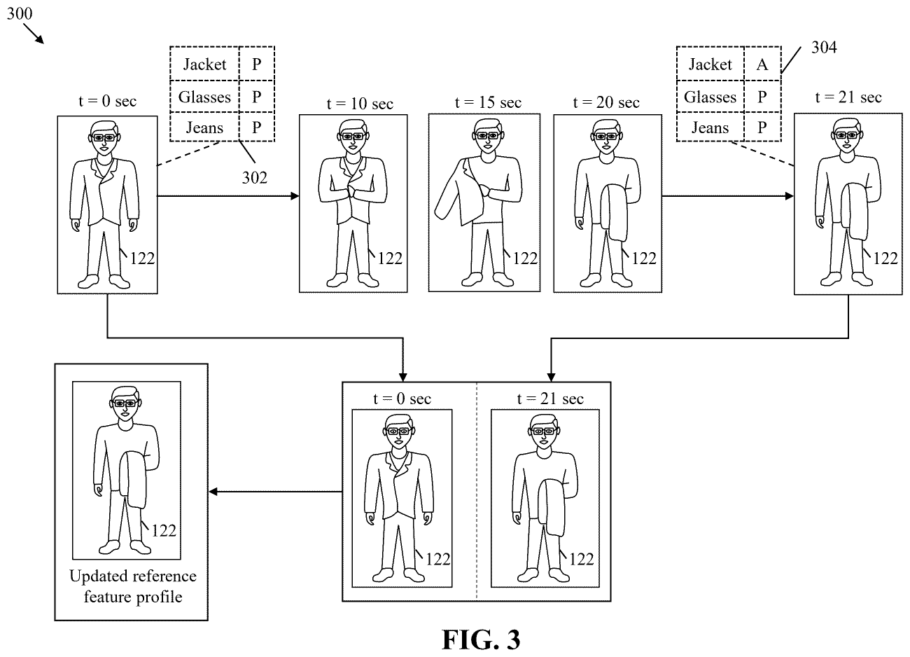

FIG. 3 is a schematic diagram that illustrates an example scenario 300 of the adaptive person ReID technique, consistent with disclosed embodiments of the present disclosure.

As illustrated in FIG. 3, at time instance t₀ (i.e., t=0 seconds (sec)), the user 122 enters the retail store 102. The first time instance t₀ is indicative of the first-time detection of the user 122. Thus, a reference feature profile is generated for the user 122 at the time instance t₀. The reference feature profile generated at time instance t₀ is stored in the profile database 124. The reference feature profile generated for the user 122 may include a set of state vectors shown in FIG. 3 in a dotted box 302. The dotted box 302 illustrates state vectors for jacket, glasses, and jeans, each with an indication that the corresponding apparel or accessory is present (denoted as “P” in FIG. 3).

Further, at time instance t₁ (i.e., t=21 sec), the current feature profile is generated for the user 122. The current feature profile generated for the user 122 may include another set of state vectors shown in FIG. 3 in a dotted box 304. The dotted box 304 illustrates state vectors for jacket, glasses, and jeans, and indications that the jacket is absent (denoted as “A” in FIG. 3) and glasses and jeans are present. Thus, at time instance t₁ (i.e., t=21 sec), an appearance-change event is detected. The appearance-change event may correspond to the removal of the jacket. In such a scenario, video frames, preceding the time instance t₁, are utilized to validate the appearance-change event. For example, video frames at time instances t₂ (i.e., t=10 sec), t₃ (i.e., t=15 sec), and t₄ (i.e., t=20 sec) are utilized. As illustrated in FIG. 3, the video frames at the time instances t₂, t₃, and t₄ may be used to determine the user action of removing the jacket. Thus, the appearance-change event is validated. Further, the current feature profile generated at the time instance t₁ and the reference feature profile stored in the profile database 124 (e.g., the reference feature profile generated at the time instance t₀) are compared. As there is a mismatch, the reference feature profile stored in the profile database 124 is updated with the current feature profile generated at the time instance t₁. The updated reference feature profile is then used for ReID of the user 122.

The scope of the present disclosure is not limited to the use of preceding video frames for the user action determination. In numerous embodiments, succeeding video frames may also be utilized.

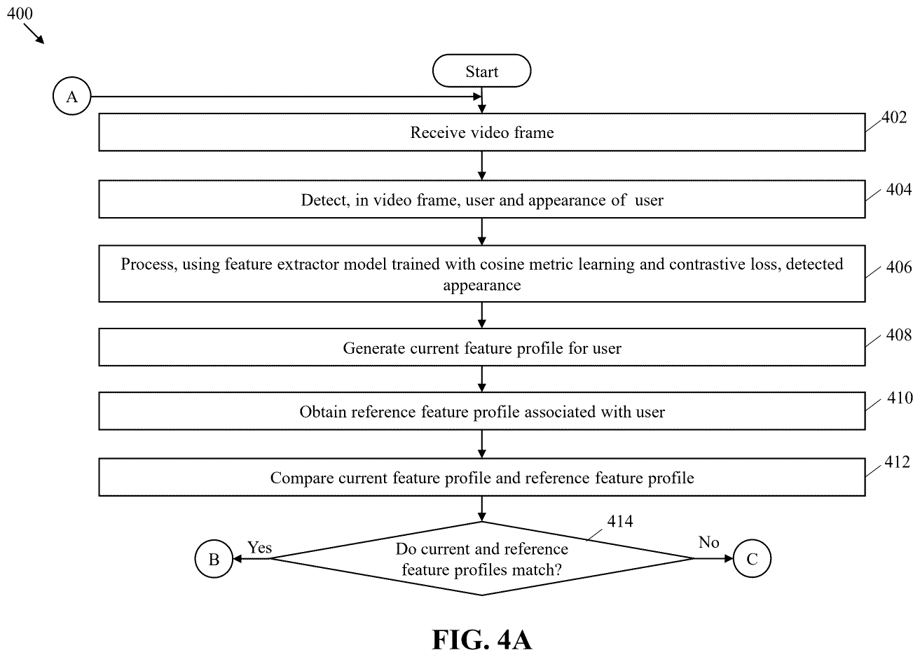

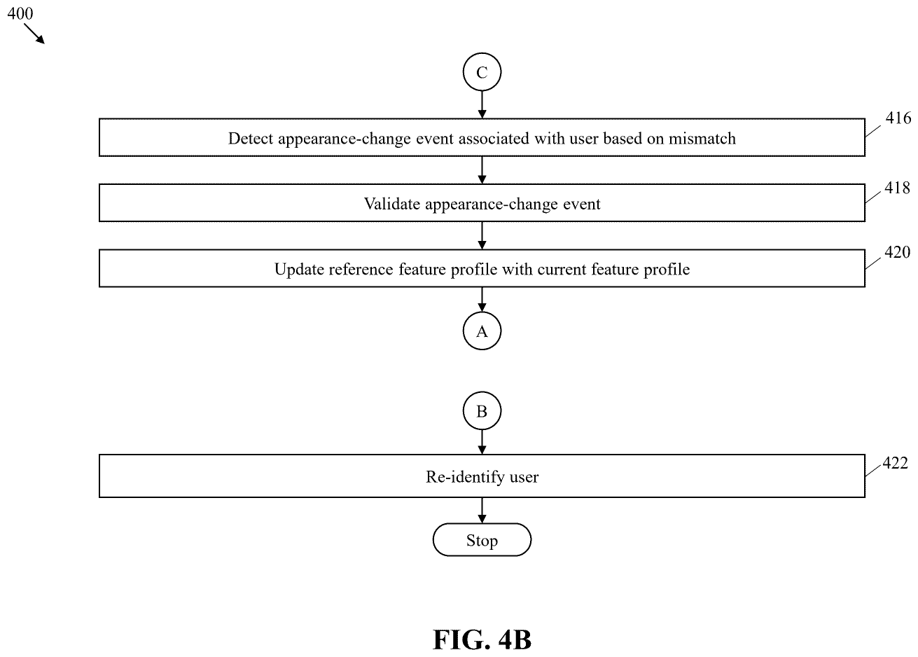

FIGS. 4A and 4B, collectively, represents a flowchart 400 that illustrates a method for adaptive person ReID, consistent with disclosed embodiments of the present disclosure.

Referring to FIG. 4A, at 402, the processing circuitry 116 (e.g., the detector 202) may receive a video frame. At 404, the processing circuitry 116 (e.g., the detector 202) may detect, in the video frame, a user (e.g., the user 122) and the appearance of the user 122. The appearance of the user 122 may be indicative of at least one of a set of apparel or a set of accessories associated with the user 122. At 406, the processing circuitry 116 (e.g., the feature extractor 204) may process, using the feature extractor model 220 trained with cosine metric learning and contrastive loss, the detected appearance. At 408, the processing circuitry 116 (e.g., the feature extractor 204) may generate the current feature profile of the user 122. The current feature profile of the user 122 is generated based on the processing of the detected appearance. At 410, the processing circuitry 116 (e.g., the profile comparator 206) may obtain the reference feature profile of the user 122. At 412, the processing circuitry 116 (e.g., the profile comparator 206) may compare the current feature profile and the reference feature profile.

At 414, the processing circuitry 116 (e.g., the profile comparator 206) may determine whether the current and reference feature profiles match. If at 414, it is determined that the current and reference feature profiles do not match, 416 is performed. Referring to FIG. 4B, at 416, the processing circuitry 116 (e.g., the profile comparator 206) detects the appearance-change event associated with the user 122 based on the mismatch. At 418, the processing circuitry 116 (e.g., the validator 208) validates the appearance-change event. At 420, the processing circuitry 116 (e.g., the profile updater 210) updates the reference feature profile with the current feature profile. 402 is performed after 420.

Referring back to FIG. 4A, if at 414, it is determined that the current and reference feature profiles match, 422 is performed. Referring back to FIG. 4B, at 422, the processing circuitry 116 (e.g., the ReID unit 212) may re-identify the user 122. The user 122 is re-identified based on the matching of the current feature profile with the reference feature profile.

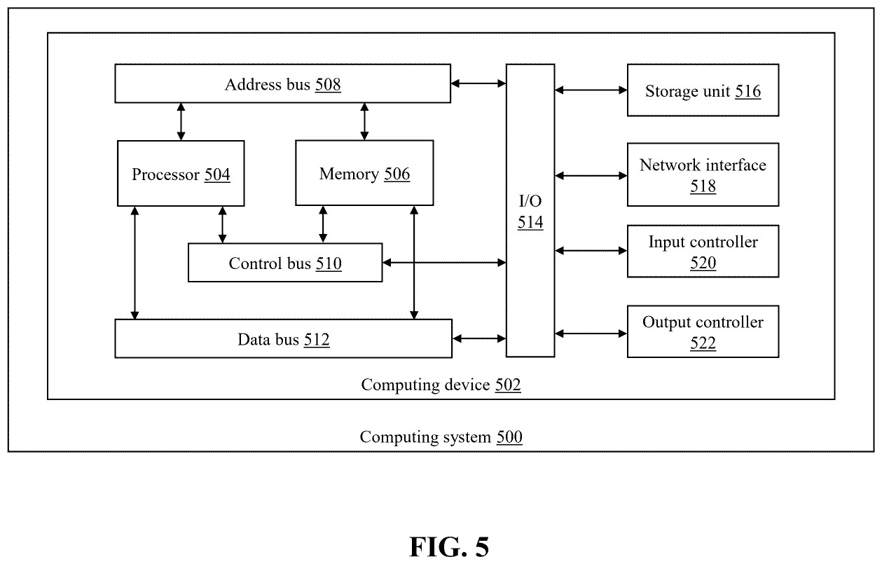

FIG. 5 shows an example computing system 500 for carrying out the methods of the present disclosure, consistent with disclosed embodiments of the present disclosure. Specifically, FIG. 5 shows a block diagram of an embodiment of the computing system 500 according to example embodiments of the present disclosure.

The computing system 500 may be configured to perform any of the operations disclosed herein. The computing system 500 may be implemented as a conventional computer system, an embedded controller, a laptop, a server, a mobile device, a smartphone, a customized machine, any other hardware platform, or any combination or multiplicity thereof. In one embodiment, the computing system 500 is a distributed system configured to function using multiple computing machines interconnected via a data network or bus system.

The computing system 500 includes computing devices (such as a computing device 502). The computing device 502 includes one or more processors (such as a processor 504) and a memory 506. The processor 504 may be any general-purpose processor(s) configured to execute a set of instructions. For example, the processor 504 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 504 may be multiple processing units, a single processing core, multiple processing cores, special purpose processing cores, co-processors, or any combination thereof. The processor 504 may be communicatively coupled to the memory 506 via an address bus 508, a control bus 510, and a data bus 512.

The memory 506 may include non-volatile memories such as a read-only memory (ROM), a programable read-only memory (PROM), an erasable programmable read-only memory (EPROM), a flash memory, or any other device capable of storing program instructions or data with or without applied power. The memory 506 may also include volatile memories, such as a random-access-memory (RAM), a static random-access-memory (SRAM), a dynamic random-access-memory (DRAM), and a synchronous dynamic random-access-memory (SDRAM). The memory 506 may include single or multiple memory modules. While the memory 506 is depicted as part of the computing device 502, a person skilled in the art will recognize that the memory 506 may be separate from the computing device 502.

The memory 506 may store information that may be accessed by the processor 504. For instance, the memory 506 (e.g., one or more non-transitory computer-readable storage mediums, memory devices) may include computer-readable instructions (not shown) that may be executed by the processor 504. The computer-readable instructions may be software written in any suitable programming language or may be implemented in hardware. Additionally, or alternatively, the computer-readable instructions may be executed in logically and/or virtually separate threads on the processor 504. For example, the memory 506 may store instructions (not shown) that when executed by the processor 504 cause the processor 504 to perform operations such as any of the operations and functions for which the computing system 500 is configured, as described herein. Additionally, or alternatively, the memory 506 may store data (not shown) that may be obtained, received, accessed, written, manipulated, created, and/or stored. The data may include, for instance, the data and/or information described herein in relation to FIGS. 1-4. In some implementations, the computing device 502 may obtain from and/or store data in one or more memory device(s) that are remote from the computing system 500.

The computing device 502 may further include an input/output (I/O) interface 514 communicatively coupled to the address bus 508, the control bus 510, and the data bus 512. The data bus 512 may include a plurality of tunnels that may support communication in the environment 100. The I/O interface 514 is configured to couple to one or more external devices (e.g., to receive and send data from/to one or more external devices). Such external devices, along with the various internal devices, may also be known as peripheral devices. The I/O interface 514 may include both electrical and physical connections for operably coupling the various peripheral devices to the computing device 502. The I/O interface 514 may be configured to communicate data, addresses, and control signals between the peripheral devices and the computing device 502. The I/O interface 514 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 514 is configured to implement only one interface or bus technology. Alternatively, the I/O interface 514 is configured to implement multiple interfaces or bus technologies. The I/O interface 514 may include one or more buffers for buffering transmissions between one or more external devices, internal devices, the computing device 502, or the processor 504. The I/O interface 514 may couple the computing device 502 to various input devices, including touch screens, scanners, biometric readers, electronic digitizers, receivers, touchpads, cameras, keyboards, any other pointing devices, or any combinations thereof. The I/O interface 514 may couple the computing device 502 to various output devices, including printers, projectors, tactile feedback devices, automation control, robotic components, actuators, transmitters, signal emitters, lights, and so forth.

The computing system 500 may further include a storage unit 516, a network interface 518, an input controller 520, and an output controller 522. The storage unit 516, the network interface 518, the input controller 520, and the output controller 522 are communicatively coupled to the central control unit (e.g., the memory 506, the address bus 508, the control bus 510, and the data bus 512) via the I/O interface 514. The network interface 518 communicatively couples the computing system 500 to one or more networks such as wide area networks (WAN), local area networks (LAN), intranets, the Internet, wireless access networks, wired networks, mobile networks, telephone networks, optical networks, or combinations thereof. The network interface 518 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 516 is a computer-readable medium, preferably a non-transitory computer-readable medium, comprising one or more programs, the one or more programs comprising instructions which when executed by the processor 504 cause the computing system 500 to perform the method steps of the present disclosure. Alternatively, the storage unit 516 is a transitory computer-readable medium. The storage unit 516 may include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 516 stores one or more operating systems, application programs, program modules, data, or any other information. The storage unit 516 is part of the computing device 502. Alternatively, the storage unit 516 is part of one or more other computing machines that are in communication with the computing device 502, such as servers, database servers, cloud storage, network attached storage, and so forth.

The input controller 520 may include suitable logic, circuitry, interfaces, and/or code, executable by the circuitry, that may be configured to control one or more input devices that may be configured to receive video frames. The output controller 522 may include suitable logic, circuitry, interfaces, and/or code, executable by the circuitry, that may be configured to control one or more output devices that may be configured to output feature profiles.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods of adaptive person ReID. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

What is claimed is:

1. A system, comprising:
processing circuitry configured to:
detect, in a first video frame, a user and an appearance of the user, wherein the appearance of the user is indicative of at least one of a set of apparel or a set of accessories associated with the user;
generate a current feature profile for the user based on the detected appearance;
obtain a reference feature profile of the user, wherein the reference feature profile is indicative of a historical appearance of the user;
compare the current feature profile and the reference feature profile;
detect an appearance-change event associated with the user based on a mismatch between the current feature profile and the reference feature profile; and
update the reference feature profile with the current feature profile based on the detection of the appearance-change event, wherein re-identification associated with the user is executed based on the updated reference feature profile.

2. The system of claim 1, wherein the historical appearance of the user corresponds to the appearance of the user detected in a second video frame that is previous to the first video frame.

3. The system of claim 1, further comprising a storage element configured to store a profile database that includes a mapping between a plurality of users and a plurality of reference feature profiles associated therewith, wherein the processing circuitry is coupled to the storage element, and configured to identify, from the plurality of reference feature profiles, the reference feature profile associated with the user.

4. The system of claim 1, wherein the processing circuitry is configured to identify the reference feature profile associated with the user based on trajectory data associated with the user and a location associated with the first video frame.

5. The system of claim 1, wherein the processing circuitry is further configured to:
detect, in a second video frame that is previous to the first video frame, the user and the historical appearance of the user;
determine whether the detection of the user corresponds to a first-time detection; and
generate the reference feature profile of the user based on the detection of the user corresponding to the first-time detection.

6. The system of claim 1, wherein the processing circuitry detects the user and the appearance of the user using at least one of a group consisting of an object detection model, a vision language model (VLM), or an instance segmentation model.

7. The system of claim 1, wherein the appearance-change event corresponds to an addition or a removal of at least one apparel of the set of apparel or at least one accessory of the set of accessories.

8. The system of claim 1, wherein the processing circuitry is further configured to validate the appearance-change event, and wherein the reference feature profile is updated based on the validation of the appearance-change event.

9. The system of claim 8,
wherein the appearance-change event indicates one or more changes in the appearance of the user,
wherein the processing circuitry is further configured to determine a user action performed by the user, and
wherein the processing circuitry validates the appearance-change event based on the user action matching the one or more changes.

10. The system of claim 9, wherein to determine the user action, the processing circuitry is further configured to:
obtain a set of video frames, wherein the set of video frames comprises at least one of a group consisting of (i) a first subset of video frames preceding the first video frame or (ii) a second subset of video frames succeeding the first video frame; and
process, using an action recognition model, the obtained set of video frames.

11. The system of claim 10,
wherein the first video frame is associated with a first image-capturing unit,
wherein at least one of the first subset of video frames is associated with a second image-capturing unit,
wherein at least one of the second subset of video frames is associated with a third image-capturing unit, and
wherein placement of the second image-capturing unit and the third image-capturing unit is within a predefined distance of placement of the first image-capturing unit.

12. The system of claim 9, wherein the determination of the user action is triggered based on the detection of the appearance-change event.

13. The system of claim 1, wherein the processing circuitry is further configured to process, using a feature extractor model trained with cosine metric learning and contrastive loss, the detected appearance of the user to generate the current feature profile of the user.

14. The system of claim 1,
wherein the processing circuitry is further configured to detect one or more additional attributes of the user,
wherein the one or more additional attributes correspond to at least one of a group consisting of (i) one or more facial features, (ii) a gait pattern, (iii) height, or (iv) a body shape of the user, and
wherein the processing circuitry generates the current feature profile of the user further based on the one or more additional attributes.

15. The system of claim 1, wherein each of the current feature profile and the reference feature profile corresponds to at least one of a group consisting of:
a set of state vectors that indicates presence or absence of each of the set of apparel and the set of accessories, or
an embedding vector that is generated for the user based on processing of the detected appearance of the user using a feature extractor model trained with cosine metric learning and contrastive loss.

16. The system of claim 15, wherein when the appearance-change event is detected, a difference between the embedding vector of the current feature profile and the embedding vector of the reference feature profile is within a tolerance range based on the cosine metric learning and contrastive loss.

17. The system of claim 1, wherein the processing circuitry is further configured to simulate, based on the updated reference feature profile, one or more appearance variations for the user, and wherein the re-identification associated with the user is executed further based on the one or more appearance variations.

18. The system of claim 17, wherein the processing circuitry simulates the one or more appearance variations using at least one of a group consisting of a generative adversarial network or a stable diffusion model.

19. The system of claim 1, wherein the processing circuitry is further configured to:
receive a third video frame that is after the first video frame;
detect, in the third video frame, the user and another appearance of the user;
generate another feature profile for the user based on the appearance detected in the third video frame;
obtain the updated reference feature profile of the user;
compare the updated reference feature profile and the other feature profile generated using the third video frame; and
re-identify the user based on a match between the updated reference feature profile and the other feature profile generated using the third video frame.

20. A method, comprising:
detecting, by processing circuitry, in a first video frame, a user and an appearance of the user, wherein the appearance of the user is indicative of at least one of a set of apparel or a set of accessories associated with the user;
generating, by the processing circuitry, a current feature profile for the user based on the detected appearance;
obtaining, by the processing circuitry, a reference feature profile of the user, wherein the reference feature profile is indicative of a historical appearance of the user;
comparing, by the processing circuitry, the current feature profile and the reference feature profile;
detecting, by the processing circuitry, an appearance-change event associated with the user based on a mismatch between the current feature profile and the reference feature profile; and
updating, by the processing circuitry, the reference feature profile with the current feature profile based on the detection of the appearance-change event, wherein re-identification associated with the user is executed based on the updated reference feature profile.
